(19) United States
(12) Patent Application Publication
(10) Pub. No.: US 2026/0168319 A1
(43) Pub. Date: Jun. 18, 2026

(54) SLIDING DOOR WITH A PIVOTABLE SEALING STRIP

(71) Applicant: Roto Frank Fenster- und Türtechnologie GmbH, Leinfelden-Echterdingen (DE)

(72) Inventors: Michael Metzger, Schönaich (DE); Richard Erb, Waldenbuch (DE); Choongeun Park, Stuttgart (DE); Ulrich Pfeiffer, Hemmingen (DE); Katharina Frank, Aichelberg (DE)

(73) Assignee: Roto Frank Fenster- und Türtechnologie GmbH, Leinfelden-Echterdingen (DE)

(21) Appl. No.: 19/532,133

(22) Filed: Feb. 6, 2026

Related U.S. Application Data
(63) Continuation of application No. PCT/EP2024/072614, filed on Aug. 9, 2024.

(30) Foreign Application Priority Data
Aug. 23, 2023 (DE) 102023208073.7

(51) Int. Cl. E06B 7/205; E05D 15/56; E06B 7/20

(52) U.S. Cl. CPC E06B 7/205; E05D 15/56; E06B 2007/202

(57) ABSTRACT

A sill arrangement has a pivotable sealing strip for a sliding door with a leaf displaceable along a running rail and which can be moved in the horizontal direction perpendicular to the running rail to be positioned against or set away from a frame. When the leaf is open, the sealing strip is lowered and it terminates flush with a sill. When the leaf is pushed closed along the running rail, the sealing strip is at least partially raised. When the pushed-closed leaf is positioned against the frame, the sealing strip can be raised further. With the leaf bearing against the frame, the raised sealing strip provides sealing against a vertical front side of the leaf. The leaf is continuously peripherally sealed against the frame in the plane of the front side of the leaf, sealing being provided by the sealing strip and further sealing structures fixed to the frame.

### CROSS-REFERENCE TO RELATED APPLICATIONS

This continuation application claims priority to PCT/EP2024/072614 filed on Aug. 9, 2024 which has published as WO 2025/040475 A1 and also the German application number 10 2023 208 073.7 filed on Aug. 23, 2023, the entire contents of which are fully incorporated herein with these references.

### DESCRIPTION

### Field of the Invention

The invention relates to a sliding door comprising a frame and a leaf, wherein the leaf—in a closed position—is movable perpendicular to its leaf plane in order to position the leaf to bear against the frame or to set it away from the frame, and wherein the leaf—when set away from the frame—is displaceable in the leaf plane in order to open or close a doorway.

### Background of the Invention

Such a sliding door is known, for example, from EP 2 829 679 B1 or from the brochure “Roto Patio Inowa-Der smarte Beschlag für hochdichte Schiebesysteme” (Roto Patio Inowa—The smart fitting for tightly sealed sliding systems) downloaded from https://media.ftt.roto-frank.com/#/reader/2e064a3c-8013-39c7-c9d3-2c65becl5d79.pdf on 11 Jul. 2023. To ensure peripheral sealing, a sill of said sliding door protrudes to a certain extent beyond the level of a walking surface.

To achieve sufficient sealing of a door leaf against a sill, various solutions have been proposed for swing doors (with a leaf hinged on one side and pivotable about a vertical axis).

For example, DE 10 2017 101 557 A1 describes a door sill with a door sill housing which, when a door leaf is closed, reliably performs the function of a high door sill and, when a door is open, is completely barrier-free without requiring an external power supply for its change of state. This is achieved by the door sill having a ground level and a raised level, and by having a movement mechanism driven by a rack that moves in the closing direction (perpendicular to a frame) of a door, which is connected to a trigger that projects above the ground level and forms a functional unit with a door shortly before the closing process is completed until the door is closed, wherein an eccentric shaft can be rotated with the rack, on which a pinion and a lifting cam are arranged, which lie under the door sill, wherein the door sill is pivotally connected to the door sill housing about a pivot joint. The door sill is hence raised when the door leaf is moved towards the door sill. The door leaf can abut against a stop surface on the front of the door sill.

A similar door sill is known from DE 10 2017 101 559 A1, wherein a drive for a camshaft for raising the door sill comprises a deflectable thrust means. The thrust means can consist of a guided spring steel band or a steel core guided in a flexible outer pull, or a guided thrust link chain.

Another similar sill for a patio or balcony door is known from DE 10 2006 029 353 B3. With this sill, an actuator for raising a strip that is partially recessed in the sill is slidably mounted in the door sill, the actuator being slidable in the closing direction (perpendicular to the frame) of the door.

DE 1 509 280 A describes a door seal for a hinged or sliding door, in which a sealing strip embedded in the floor is pushed upwards when the door is closed. A double-armed lever lifts the sealing strip in a vertical direction. The lever is angled at its pivot point. One of the lever's legs is in operative connection with the sealing strip, and the other short leg of the lever is in operative connection with the narrow surface of the door facing the hinges.

A similar lifting sill is known from DE 10 2017 101 555 A1. A pivot lever for raising a door sill is mounted here so as to be pivotable about a vertical pivot axis and acts on the door sill via a cam mechanism, so that the door sill hits the underside of the door from below when the door is closed.

Other door sills with sealing strips that can be moved translationally in the vertical direction are known from U.S. Pat. No. 7,028,740 B2, US 2011/0265386 A1 or EP3458 669 B1.

### SUMMARY OF THE INVENTION

Object of the invention: It is an object of the invention to enable an effective

sealing of a sliding door of the type mentioned above with a barrier-free or at least low-barrier sill.

Description of the invention: This object is achieved according to the invention by a sliding door according to the claims, a sill arrangement according to claims, and a frame according to claims. Advantageous embodiments are specified in the dependent claims and the description.

According to the invention, a sliding door is provided. The sliding door has a frame and a leaf. In a closed position, the leaf is movable perpendicular to its leaf plane in order to position the leaf against the frame or to move it away from the frame. The movement for positioning the leaf against the frame and setting the leaf away from the frame is generally strictly perpendicular to the leaf plane. The movement for making the leaf bear against or setting it away from the frame is, in particular, a purely translational movement. In the closed position, the leaf completely covers the doorway. The closed position can also be referred to as an end position of the leaf. When positioned away from the frame, the leaf can be moved in the leaf plane to open or close a doorway.

The sill can have a running rail along which the leaf is displaceable after the leaf has been moved away from the frame. The leaf can have a carriage for moving the leaf along the running rail. The carriage is preferably coupled to a handle, and actuation of the handle causes the leaf to move perpendicularly to the running rail. The carriage can have a suitable mechanism for this purpose, for example with a transverse guide. The movement triggered by the carriage when the handle is operated generally has no component along the running rail; it therefore occurs strictly perpendicular to the running rail or leaf plane.

The frame has a sill on which a sealing strip is arranged that can pivot between a lowered and a raised position. A pivot axis of the sealing strip runs parallel to the leaf plane. The pivot axis thus extends parallel to the displacement direction of the leaf.

The pivot axis can be an imaginary or physical axis of the pivoting movement of the sealing strip. A pivotable sealing strip is easy to actuate in order to move it between the lowered and raised position, is particularly durable and requires only a low installation height below its upper side, for example for fastening or mounting the sealing strip or a mechanism for raising the sealing strip.

In the lowered position, the sealing strip preferably closes flush with an upper side of the sill, in particular, a tread plate of the sill. In the lowered position, which is established when the leaf is open, the sealing strip can be easily crossed, in particular, with walking aids or wheelchairs, or traversed without risk of getting caught. The tread plate can create a flush (level) connection between the sill and a walking surface. It shall be understood that the tread plate can be made of a sheet, in particular, a metal sheet, or any other suitable material, e.g., plastic. In particular, the tread plate can be manufactured as an extruded profile or an injection-molded part.

In the raised position, the sealing strip protrudes beyond an upper side of the sill, in particular, the tread plate of the sill. The raised sealing strip enables effective sealing of the sliding door.

In its position when bearing against the frame, the leaf touches the raised sealing strip with a front side (facing the frame). This reliably creates a sealing in the lower region of the leaf. The front side typically corresponds to an outer side of the leaf. Preferably, the leaf, when bearing against the frame, bears peripherally against a sealing arrangement of the frame. In particular, the frame can have a peripheral sealing arrangement that runs continuously in one plane for the leaf to abut, wherein the sealing strip is part of the peripheral sealing arrangement. This ensures an all-around seal between the leaf and the frame. Sealing in one plane on the front side of the leaf avoids potentially leaky areas. Furthermore, sealing in a common plane simplifies the design of the sealing arrangement for reliable sealing regardless of manufacturing and assembly tolerances and any wear.

For the purpose of the description of the present invention, directional or positional references, such as above or below, refer to the installed state of the sliding door.

The sliding door has an actuating element for raising the sealing strip, which is configured to raise the sealing strip from the lowered position when the leaf (while it is set away from the frame) is moved to the closed position. The actuating element thus lifts the sealing strip as soon as the leaf is moved to the closed position parallel to the leaf plane. In other words, the sealing strip is at least partially raised as the leaf is moved in the displacement direction parallel to the sill (along a running rail). This makes it possible to establish contact between the sealing strip and the front side of the frame when positioning the leaf to bear against the frame, without the risk of the sealing strip getting stuck on the leaf.

The actuating element typically interacts with the leaf by the leaf coming into contact with the actuating element during the last part, approximately the last 0.5 to 5 centimeters, of its displacement movement as it is moved to the closed position. It can be provided, in particular, that when the leaf is moved, a vertical leaf mullion with a narrow side oriented transversely to the leaf plane or a frame-side edge of this narrow side engages the actuating element. This prevents the actuating element from protruding disruptively into the doorway.

The actuating element is preferably rotatable about a rotation axis. This allows for a strong design and can help to keep manufacturing costs low.

The actuating element and the sealing strip are preferably arranged in such a way that the sealing strip moves to the lowered position by the effect of gravity when the leaf is pushed out of the closed position to clear the doorway. Alternatively or additionally, a spring element can be provided to move the sealing strip to the lowered position.

In an advantageous embodiment, the actuating element is configured to move the sealing strip completely to the raised position when the leaf is moved to the closed position. This can simplify the interaction between the leaf and the actuating element.

In an alternative, equally advantageous embodiment, the actuating element is configured to raise the sealing strip to an intermediate position when the leaf is moved to the closed position. Then, when the leaf is positioned against the frame, the sealing strip is moved from the intermediate position to the raised position. The sealing strip can be further moved from the intermediate position to the raised position by the actuating element and/or directly by the leaf. In the intermediate position, the sealing strip is raised less than in the raised position. The two-stage lifting process allows for a comparatively large raising movement at the sealing strip.

In an advantageous embodiment, a rotation axis of the actuating element is aligned perpendicularly to the pivot axis of the sealing strip. The rotation axis typically runs perpendicular to the leaf plane. This can simplify the design of the actuating element. This embodiment is particularly suitable if the sealing strip is to be fully raised when the leaf is moved to the closed position.

In a further development of this embodiment, the actuating element is a rotatably mounted lever with two legs, wherein a first leg engages under the sealing strip and a second leg protrudes upwards, so that it is deflected by the leaf when the leaf is moved to the closed position. The kinematic transmission ratio of the actuating element can be adjusted by varying the leg lengths in order to achieve complete raising of the sealing strip on a small displacement path of the leaf.

The angle between the legs can be at least 60°, preferably at least 70°, and/or at most 85°, preferably at most 80°. The lever can be configured, in particular, to rotate by 15°+/−5° in order to move the sealing strip from the lowered position to the raised position.

In an alternative, equally advantageous embodiment, a rotation axis of the actuating element corresponds to the pivot axis of the sealing strip, preferably wherein the actuating element is fixed to the sealing strip. This can reduce the complexity of the mechanics; in particular, a separate mounting of the actuating element can be dispensed with. This embodiment is particularly suitable if the sealing strip is to be raised to an intermediate position when the leaf is moved to the closed position and then fully raised when the leaf is positioned against the frame.

In a further development of this embodiment, the actuating element has a contact surface for the leaf that is inclined relative to the rotation axis, in particular, wherein the contact surface is curved. When moving the moved-away leaf to the closed position, the inclination or curvature of the contact surface can influence the kinematic transmission ratio of the actuating element. Preferably, the contact surface protrudes horizontally beyond the sealing strip in the lowered position of the sealing strip. This allows the leaf, when moved to the closed position, to engage the actuating element with an edge of a vertical leaf mullion without coming into contact with the sealing strip.

In a particularly preferred embodiment, the sealing strip has a sealing profile with two end regions, wherein a first end region of the sealing profile forms at least one sealing lip for contact with the leaf and a second end region of the sealing profile is fixed to the sill, in particular, to a tread plate of the sill, and wherein a deformation portion is formed in the sealing profile between the second end region and the first end region, wherein the deformation portion defines the pivot axis. In other words, the deformation portion acts like an integral hinge. This allows for a particularly simple and robust design of the sill arrangement. Also, connecting the sealing profile to the sill prevents formation of a gap between the sealing strip and the sill, in particular, between the sealing strip and the tread plate. The deformation portion of the sealing profile further enables virtually wear-free pivoting of the sealing strip. A cavity may be provided within the sealing lip; such a sealing lip can also be referred to as a balloon seal.

In an advantageous development of this embodiment, the sealing strip has a stiffening element for the sealing profile, which is arranged between the deformation portion and the sealing lip. On the one hand, the stiffening element increases the stability of the sealing strip under stress caused by walking or driving over it. On the other hand, stiffening the sealing profile can provide a greater contact force against the leaf, which improves the sealing effect. The sealing profile can be injection-molded or cast onto the stiffening element. This allows for efficient production of the sealing strip. In particular, the stiffening element can be overmolded or cast with a sealing profile. In other words, the stiffening element can be embedded in the sealing profile. This results in a particularly durable connection between the stiffening element and the sealing profile.

In an alternative, equally advantageous embodiment, the sealing strip has a support profile and a sealing element held on the support profile, wherein the support profile is pivotably mounted on the sill. This can simplify the installation of the sealing strip on the sill. Also, the defined mounting of the support profile on the sill allows the movement of the sealing strip to be determined with particular precision. In particular, the support profile can have a calotte groove extending along the pivot axis, into which a hinge projection of the sill engages. The calotte groove typically has a rounded, in particular, circular, cross-section. The rounded shape of the calotte groove makes it easier to pivot the sealing strip relative to the sill in a hinge-like manner. The hinge projection preferably extends over at least 70%, and, in particular, at least 85%, of the length along the calotte groove. The hinge projection can consist of several sub-portions.

In an advantageous development of this embodiment, the support profile has a stop portion for contact with the sill when the sealing strip is in the raised position. The stop portion prevents the sealing strip from unintentionally extending beyond its raised position, thus ensuring a sufficiently high contact force of the sealing strip against the front side of the leaf.

The frame can have a vertical mullion and a corner piece arranged in the corner region of the vertical mullion and the sill, against which corner piece the leaf bears in its position when bearing against the frame. The corner piece thus contributes to sealing the leaf against the frame in the corner region. The corner piece can be part of a peripheral sealing arrangement that runs continuously in one plane. In particular, the corner piece can be compressed when the leaf is positioned against the frame.

Preferably, when the leaf is positioned to bear against the frame, the actuating element is accommodated in the corner piece. This embodiment is particularly suitable for an actuating element that can be raised about a rotation axis that runs parallel to the pivot axis or coincides with the pivot axis. The actuating element then does not impair the sealing effect in the corner region.

Preferably, the actuating element bears against the corner piece when the sealing strip is in the raised position. The corner piece thus acts as a stop for the actuating element. This prevents the sealing strip from unintentionally extending further beyond its raised position. This ensures a sufficiently high contact force of the sealing strip against the front side of the leaf.

The sealing strip can have one sealing lip for front-side contact with the leaf and a further sealing lip for contact with the underside of the leaf. In this way, a particularly effective seal can be achieved. A free end of a sealing profile or sealing element of the sealing strip facing the leaf can be U-shaped, so that the two sealing lips are each formed by one of the legs of the U-shaped end.

An additional seal can be arranged on the underside of the leaf, wherein a vertical sealing surface is formed within the sill for contact of the additional seal when the leaf is bearing against the frame. This can further improve the seal between the leaf and the frame. The additional seal is typically not located in the plane of a peripheral sealing arrangement for front-side contact with the leaf. The vertical sealing surface within the sill is generally located below an upper side of the sill.

The present invention further relates to a sill arrangement for a frame for a sliding door, in particular, for a sliding door according to the invention as described above. The sill arrangement comprises a sill and a sealing strip, wherein the sealing strip is pivotably arranged on the sill to be pivotable between a lowered and a raised position, wherein a pivot axis runs along the sill, and wherein the sill arrangement further comprises an actuating element for raising the sealing strip, which is configured to raise the sealing strip from the lowered position when a leaf of the sliding door is moved along the sill (in a displacement direction parallel to the sill) to a closed position. The sill can consist of one or more parts and can, for example, have a base body and a tread plate. For further features and advantages of the sill and sealing strip, please refer to the description above.

The present invention also relates to a frame for a sliding door, in particular, for a sliding door according to the invention as described above, comprising two vertical mullions, an upper horizontal mullion and a sill arrangement according to the invention as described above. For further features and advantages of the frame, please refer to the description above. In particular, sealing elements of a peripheral sealing arrangement that runs continuously in one plane can be arranged on the two vertical mullions and the upper horizontal mullion.

Further features and advantages of the invention can be found in the description, the claims, and the drawings. Likewise, the aforementioned features and those which are to be explained below can each be used individually or as a plurality in expedient combinations of any kind. The embodiments shown and described are not to be understood as an exhaustive list, but, rather, have an exemplary character for the description of the invention.

### BRIEF DESCRIPTION OF THE DRAWINGS

The invention is shown in the drawings and is described on the basis of embodiments:

FIG. 1 shows a schematic diagram of a sliding door according to the invention;

FIG. 2 shows an embodiment of a sliding door according to the invention with a leaf and a frame in a schematic perspective view looking at a first corner region between a sill and a vertical mullion of the frame, where a corner piece is arranged, in an open state;

FIG. 3 shows the sliding door of FIG. 2 in the fully closed state, in a first schematic perspective view looking at the first corner region with the corner piece;

FIG. 4 shows the sliding door of FIG. 2 in the fully closed state, in a second schematic perspective view looking at a second corner region in which a further corner piece is arranged;

FIG. 5 shows a corner region of a frame of the sliding door of FIG. 2, wherein a sealing strip is in a lowered position, in a schematic perspective view;

FIG. 6 shows the corner region shown in FIG. 5, wherein the sealing strip is in a raised position, in a schematic perspective view;

FIG. 7 shows the open sliding door of FIG. 2 in a schematic cross-sectional view through a central region of the leaf and a sill of the frame;

FIG. 8 shows a schematic cross-sectional view through the central region of the sill and frame of the sliding door of FIG. 2 with the leaf bearing against the frame;

FIG. 9 shows the open sliding door of FIG. 2 in a schematic cross-sectional view through the corner piece in the first corner region, with the leaf open;

FIG. 9a shows an enlarged section of FIG. 9 in the region of an actuating element for the sealing strip;

FIG. 10 shows a schematic cross-sectional view through the corner piece in the first corner region of the sliding door of FIG. 2 with the leaf bearing against the frame;

FIG. 11 shows a schematic cross-sectional view through the corner piece in the first corner region of the sliding door of FIG. 2, wherein the leaf is moved along a running rail into a closed position, but is still positioned away from the frame, so that the sealing strip is in an intermediate position;

FIG. 12 shows the sliding door of FIG. 2 in a schematic perspective view looking at the first corner region, wherein the leaf, that is set away from the frame, is in the closed position, in which the actuating element bears against a front side of the leaf and lifts the sealing strip into the intermediate position;

FIG. 13 shows a further embodiment of a sliding door according to the invention with a leaf and a frame in a schematic longitudinal section, with the leaf open;

FIG. 14 shows the sliding door of FIG. 13 with the leaf closed, in a schematic longitudinal section;

FIG. 15 shows the sliding door of FIG. 13 in a schematic cross-section with the leaf open;

FIG. 15a shows an enlarged section of FIG. 15 in the region of a sealing strip; and

FIG. 16 shows the sliding door of FIG. 13 in a schematic cross-section with the leaf bearing against the frame.

### DETAILED DESCRIPTION OF THE PREFERRED EMBODIMENTS

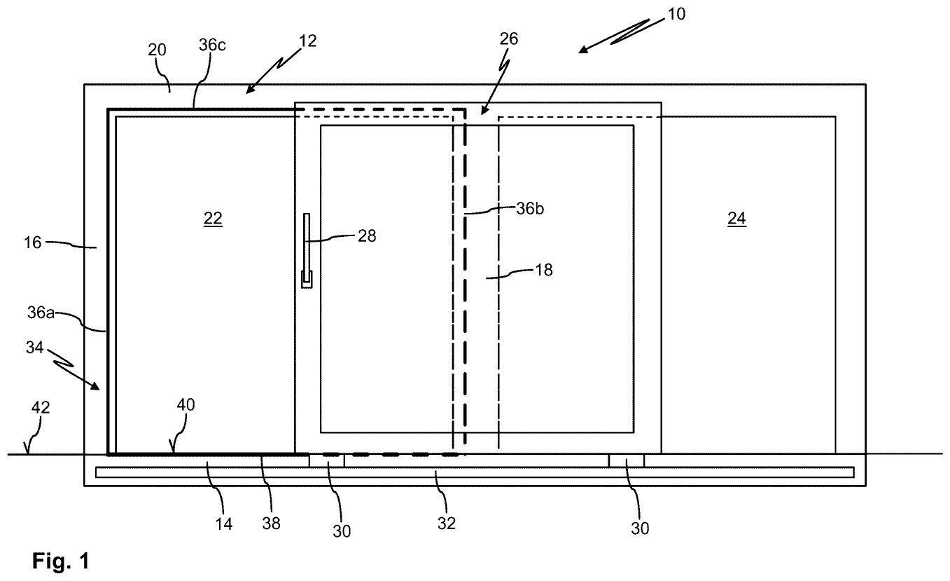

FIG. 1 shows a sliding door 10. A building-mounted frame 12 has a sill 14, two vertical mullions 16,18 and an upper horizontal mullion 20. The sill 14 and the mullions 16, 18, 20 surround a doorway 22. The frame can moreover have a further field 24, in particular, with fixed glazing.

The sliding door 10 further has a leaf 26. The leaf 26 can optionally close or open the doorway 22. FIG. 1 shows a partially opened state.

To close the sliding door 10, the leaf 26 is moved to a closed position in front of the doorway 22 (to the left in FIG. 1) and then positioned to bear against the frame 12 by operating a handle 28. For this purpose, the handle 28 is coupled with a carriage 30 and optionally with other fitting parts (not shown in detail) in a manner known per se. When the leaf 26 is set away (positioned at a distance) from the frame 12 by appropriately operating the handle 28, the leaf 26 can be displaced along a running rail 32, on which the carriages 30 sit, to open or cover the doorway 22. A leaf plane in which the leaf 26 extends (parallel to the drawing plane of FIG. 1) is oriented parallel to the running rail 32. The running rail 32 extends along the sill 14.

The leaf 26 is movable in the manner described above, on the one hand along the running rail 32 and on the other hand perpendicular to the running rail 32 or perpendicular to the leaf plane. The movement of the leaf 26 along the running rail 32 to open or close the doorway 22 is only possible when the leaf 26 has been moved away from the frame 12. In particular, in the closed position, the leaf 26 can be moved perpendicular to the running rail 32 in order to position the leaf 26 against the frame 12 or to move it away from the frame 12. The closed position, in which the leaf 26 completely covers the doorway 22, is defined by a stop which is not shown in detail.

In the state positioned against the frame 12, the leaf 26 bears against a sealing arrangement 34 that continuously surrounds the doorway 22. The sealing arrangement 34 has sealing strands 36a, 36b, 36c that extend along the two vertical mullions 16, 18 and the upper horizontal mullion 20. In addition, the sealing arrangement 34 has a pivotable sealing strip 38, which extends along the sill 14.

In FIG. 1, the sealing strip 38 is in a lowered position in which it is flush with an upper side 40 of the sill 14. When closing the leaf 26, the sealing strip 38 is raised so that it comes into contact with the front side of the leaf 26. This is illustrated in more detail below using two embodiments.

The sliding door 10 of FIG. 1 is barrier-free. The upper side 40 of the sill 14 is arranged at least approximately at the level of an adjacent walking surface 42. Thus, the sealing strip 38 in the lowered position, i.e., with the leaf 26 open, is also arranged at least approximately at the level of the walking surface 42. The walking surface can be an interior and/or exterior floor surface of the building.

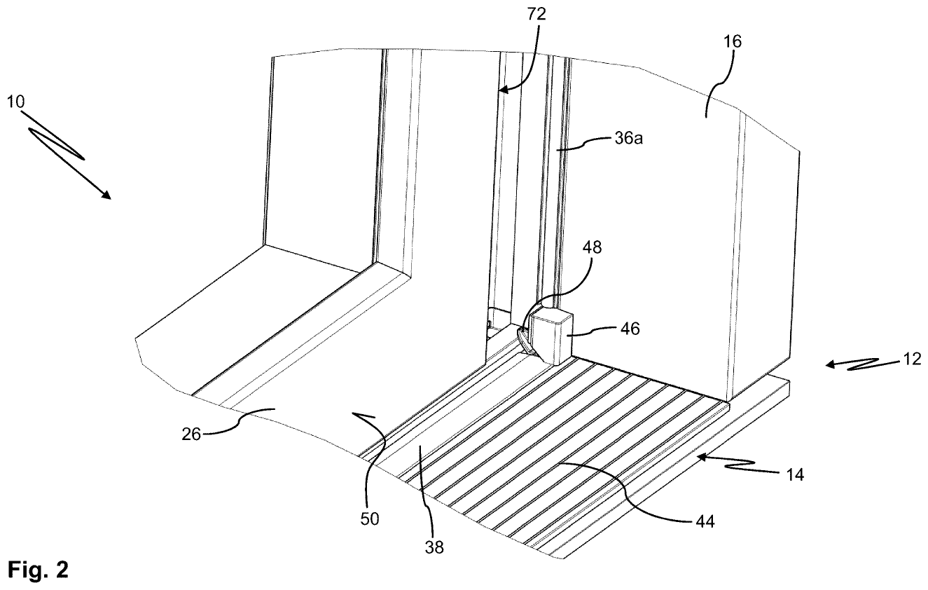

FIG. 2 shows a sliding door 10 with a slightly opened leaf 26 that is moved away, perpendicular to its leaf plane, from a frame 12. FIG. 2 shows a corner region between a sill 14 and a vertical mullion 16.

The sill 14 has a tread plate 44 on its upper side. A sealing strip 38 is arranged on the sill 14 adjacent to the tread plate 44. In FIG. 2, the sealing strip 38 is in a lowered position in which it is flush with the tread plate 44.

A corner piece 46 is arranged in the corner region between the vertical mullion 16 and the sill 14. The corner piece 46 is located directly below a sealing strand 36a attached to the vertical mullion 16.

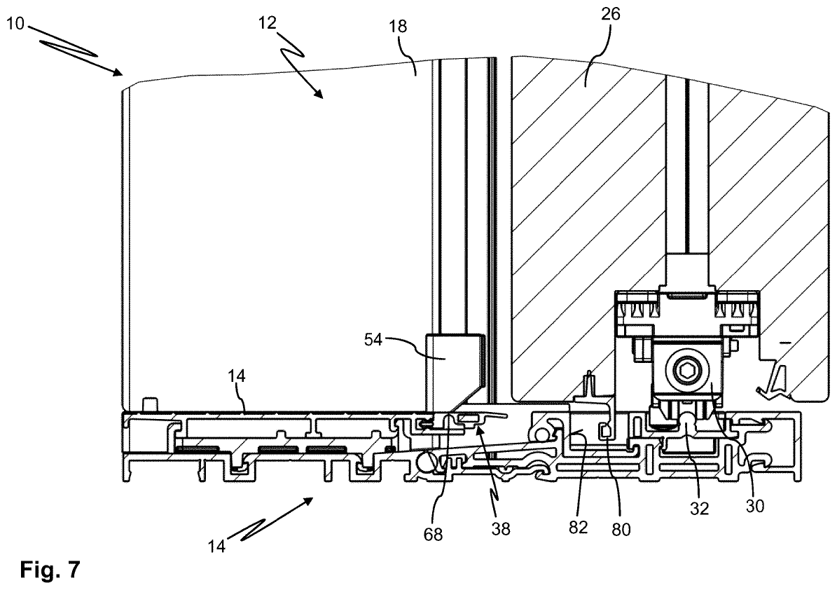

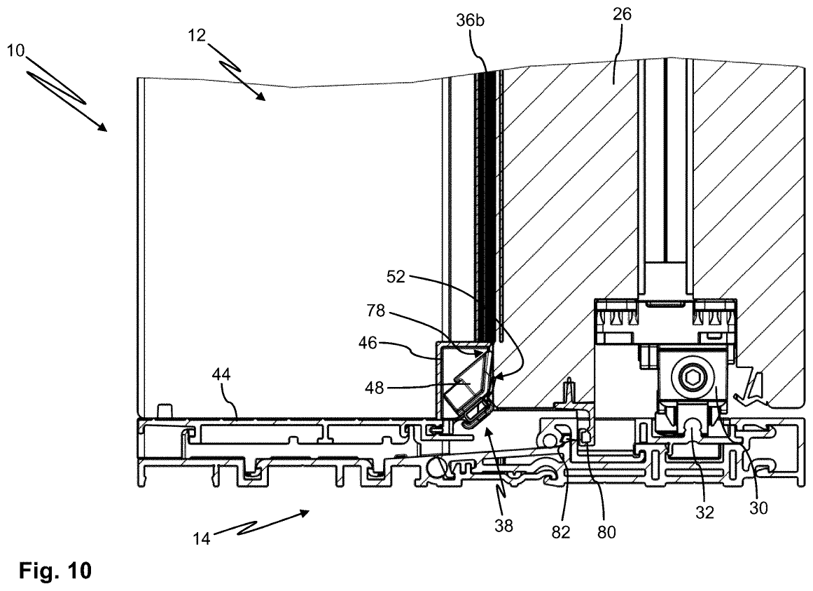

An actuating element 48 for the sealing strip 38 is arranged with the corner piece 46 and faces the leaf 26. With the sealing strip 38 lowered or the leaf 26 set away from the frame 12, the actuating element 48 protrudes away from the corner piece 46, namely towards a front side 50 of the (pushed closed) leaf 26; cf. also FIG. 5. The actuating element 48 protrudes above the plane of a peripheral sealing arrangement 34, which comprises the sealing strand 36a and the corner piece 46. In particular, the actuating element 48 protrudes above a sealing lip 52 of the sealing strip 38 transversely to the sill 14 or sealing strip 38; cf. also FIG. 9.

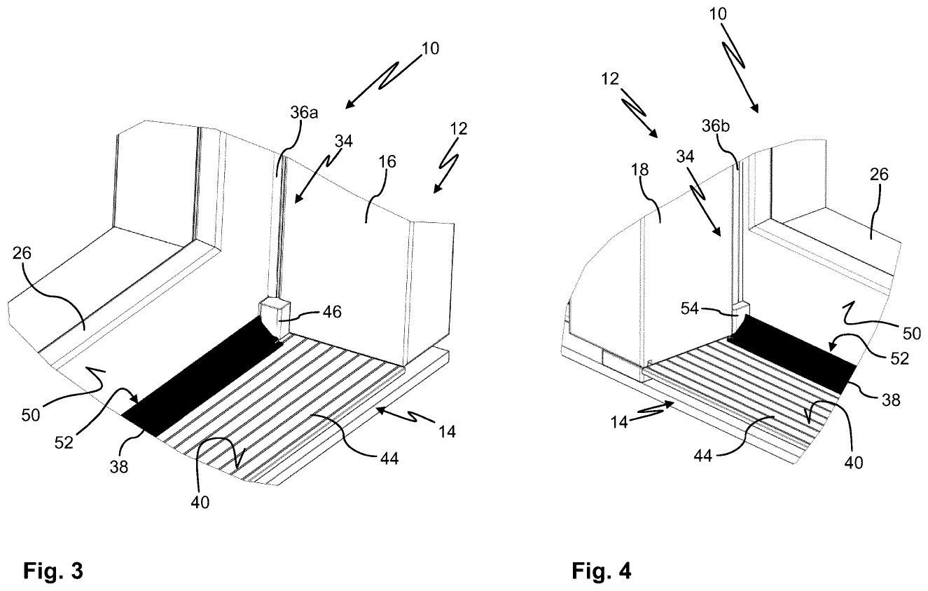

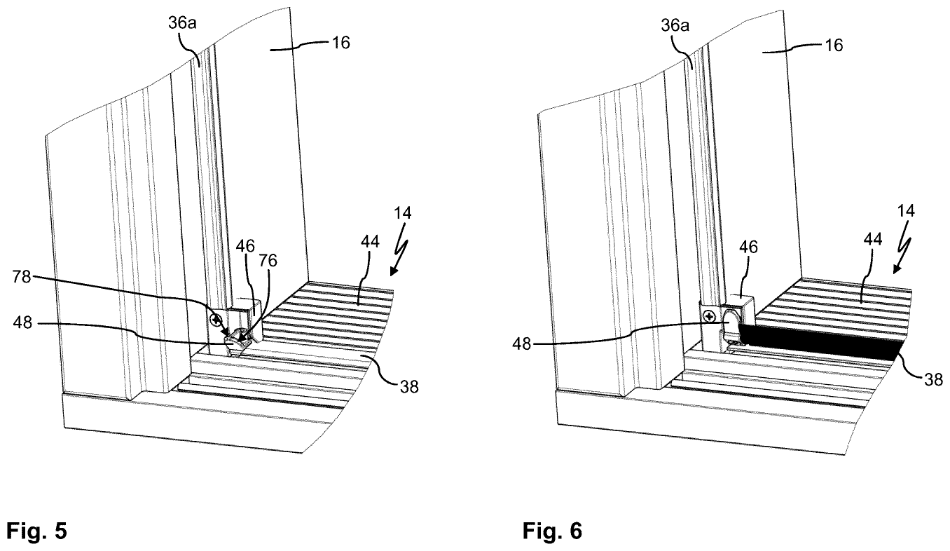

In FIGS. 3 and 4, the sliding door 10 is shown with the leaf 26 closed and positioned to bear against the frame 12. FIG. 3 shows the corner region of the sill 14 and vertical mullion 16 with the corner piece 46. FIG. 4 shows a corner region at the other end of the sill 14 at the vertical mullion 18. There, another corner piece 54 is arranged below the sealing strand 36b.

With the leaf 26 bearing against the frame 12, the sealing strip 38 is in a raised position. The sealing strip 38 protrudes upwards above an upper side 40 of the sill 14, in particular, of the tread plate 44.

The leaf 26 bears with its front side 50 against the sealing lip 52 of the sealing strip 38. Furthermore, the front side 50 of the leaf 26 bears against the two corner pieces 46, 54 and against the vertical sealing strands 36a, 36b and against a horizontal sealing strand 36c at an upper horizontal mullion 20 (cf. FIG. 1). The leaf 26 is thus continuously peripherally sealed off against the frame 12 in the plane of its front side 50. The sealing strip 38, the sealing strands 36a, 36b, 36c and the corner pieces 46, 54 thus form a closed peripheral sealing arrangement 34 for sealing in a common sealing plane, namely the plane of the front side 50 of the leaf 26.

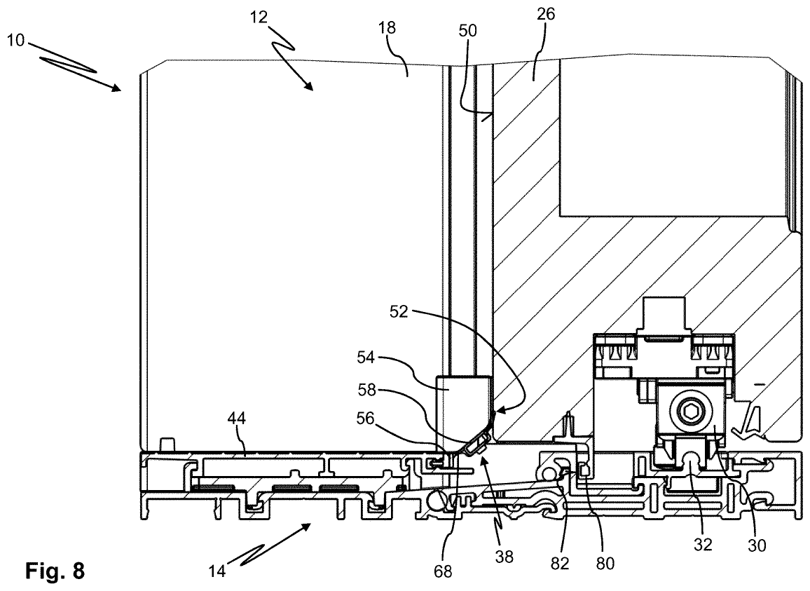

When the leaf 26 bears against the frame 12, specifically the peripheral sealing arrangement 34, the actuating element 48 is received in the corner piece 36 in this embodiment; cf. FIG. 6. This enables, on the one hand, the front-side bearing of the leaf 26 against the corner piece 46.

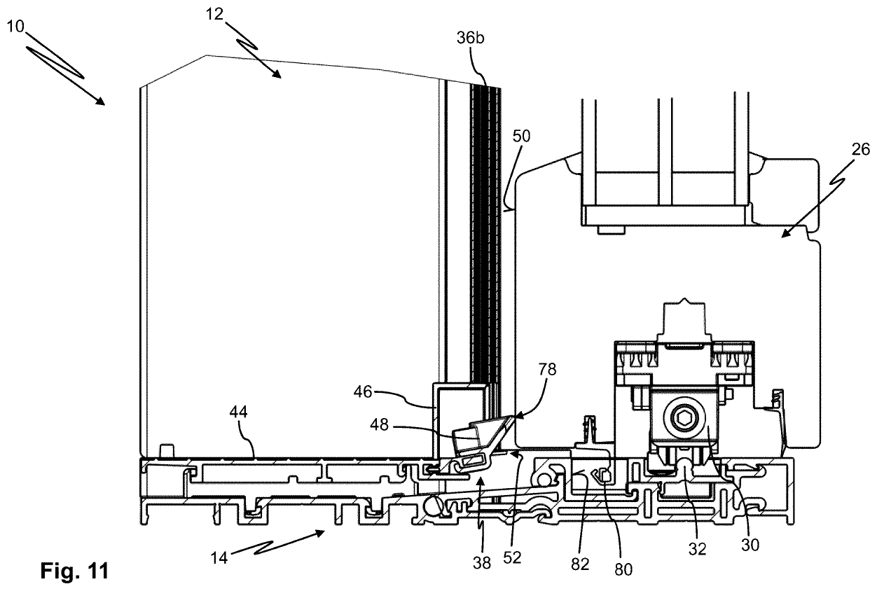

On the other hand, the corner piece 46 can act as a stop for the actuating element 48, cf. also FIG. 10. The raised position of the sealing strip 38 is defined by the actuating element 48 bearing against the corner piece 46. This also prevents the sealing strip 38 from being pivoted beyond the raised position, which could reduce the sealing effect.

In this embodiment, the sealing strip 38 has a sealing profile 56 in which a stiffening element 58 is embedded; cf. FIG. 9a.

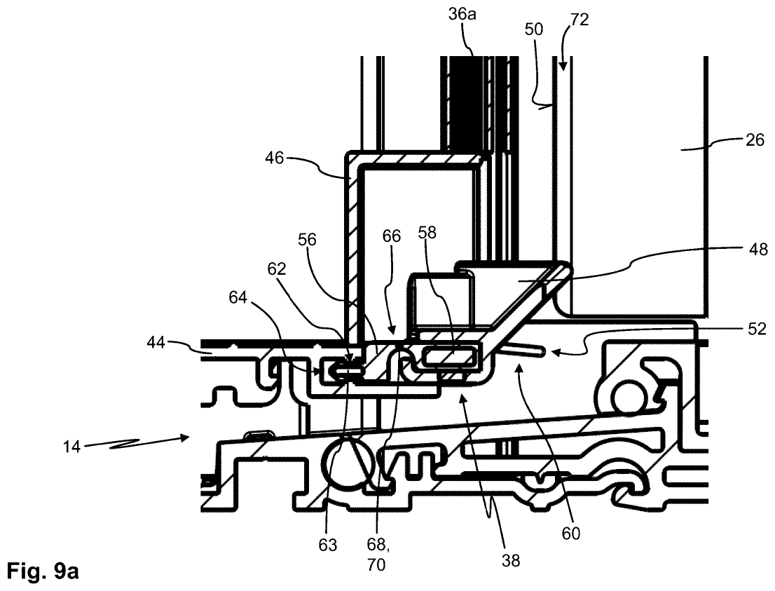

At a first end region 60 of the sealing profile 56, the sealing lip 52 is designed to bear against the leaf 26. In the raised position of the sealing strip 38, the sealing lip 52 can be bent upwards relative to the stiffening element 58 by contact with the leaf 26; cf. FIGS. 8 and 10. The stop between the actuating element 48 and the corner piece 46 thus defines the orientation of the stiffening element 58 for the raised position of the sealing strip 38; the sealing lip 52 is deformed by the leaf 26 bearing against the frame 12, resulting in the sealing lip 52 being pressed against the front side 50 of the leaf 26, which contact pressure is defined by the elasticity of the sealing profile 56 in the first end region 60.

A second end region 62 of the sealing profile 56 is fixed at the sill 14, here at its upper-side tread plate 44; cf., in particular, FIG. 9a. For this purpose, the second end region 62 can be received and clamped in a groove 64 of the tread plate 44; projections and/or ribs can be provided in the groove 64 which compress and/or engage behind the sealing profile 56. In the second end region 62, an insert 63 can be embedded in the sealing profile 56. This improves fixation of the sealing profile 56 at the tread plate 44.

The two end regions 60, 62 are arranged on different sides of the stiffening element 58.

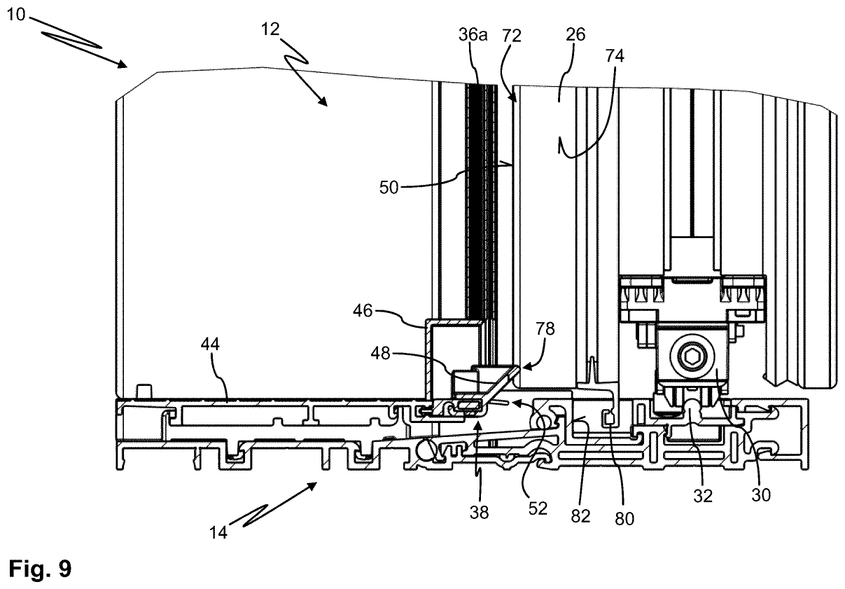

A deformation portion 66 is formed in the sealing profile 56 between the second end region 62 and the stiffening element 58. The sealing profile 56 has a reduced thickness in the deformation portion 66. The deformation portion 66 thus defines a pivot axis 68 about which the sealing strip 38 is pivoted between the lowered and the raised position; cf. also FIG. 7 for the lowered position and FIG. 8 for the raised position. The pivot axis 68 runs perpendicular to the drawing plane along the sill 14 in FIGS. 7 and 8. Thus, the pivot axis 68 also extends parallel to the leaf plane of the leaf 26 and to a running rail 32 on which the leaf 26 with its carriages 30 can be moved (provided it is removed from the frame 12).

In this embodiment, the actuating element 48 is fixed to the sealing strip 38, in particular, to its stiffening element 58; cf. FIG. 9a.

Here, the actuating element 48 engages the stiffening element 58 on the top and bottom. Furthermore, a screw of the actuating element 48 can penetrate the sealing profile 56 and the stiffening element 58 (not shown in detail). A rotation axis 70 of the actuating element 48 thus corresponds to the pivot axis 68 of the sealing strip 38. In this embodiment, a separate mounting of the actuating element 48 is not provided.

When the leaf 26 is open, i.e., moved away from the frame 12 and pushed out of the closed position, an edge 72 between the front side 50 and a narrow side 74 of the leaf 26 facing the vertical mullion 16 when viewed along the sill 14 or along the running rail 32 is arranged behind the part of the actuating element 48, which protrudes above the sealing lip 52; cf. FIGS. 2 and 9.

When the leaf 26 is pushed into the closed position, the edge 72 hits the actuating element 48 shortly before the closed position is reached. A contact surface 76 is formed on the actuating element 48 which the leaf 26 comes into contact with; cf. FIG. 5. The contact surface 76 is inclined relative to the pivot axis 70, which here coincides with the rotation axis 68. In particular, the contact surface 76 is curved.

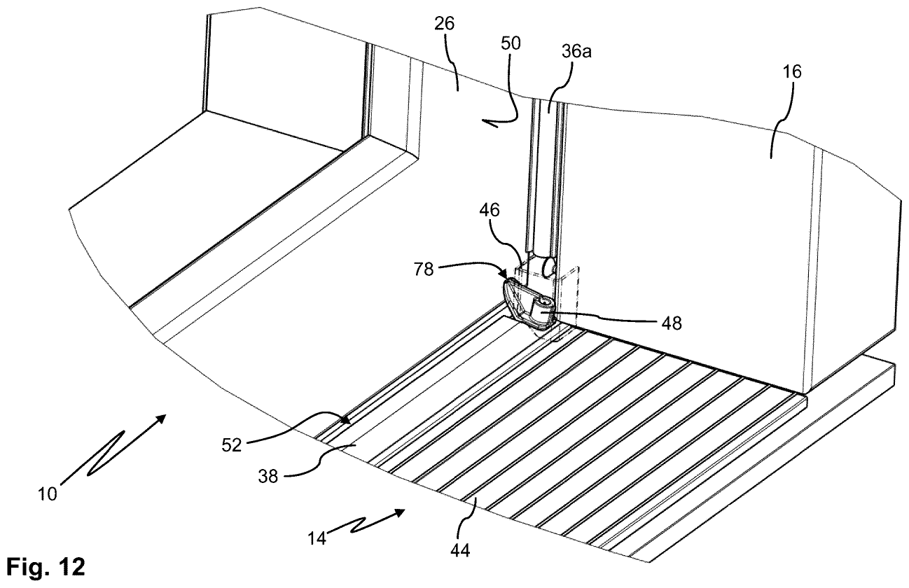

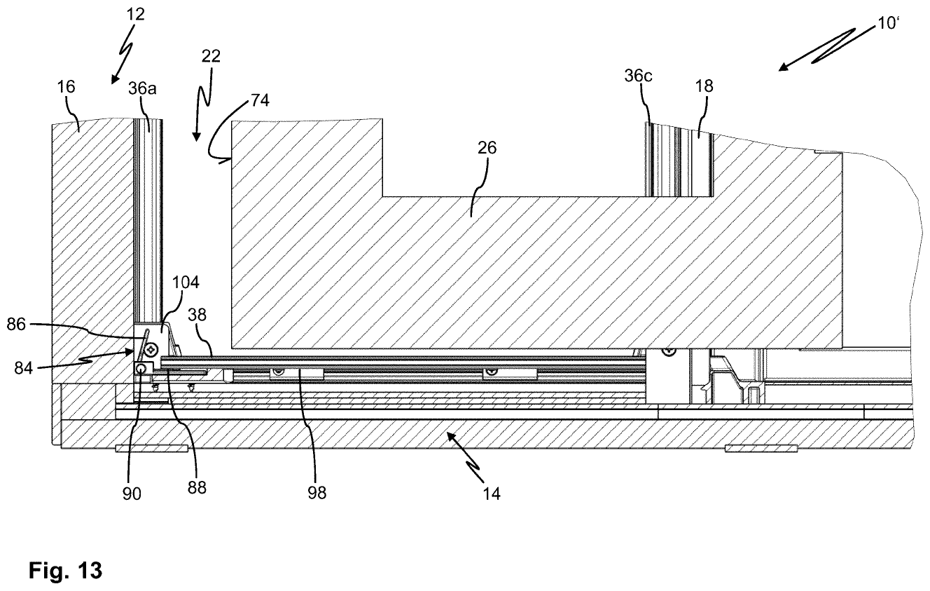

As the leaf 26 is pushed closed further, the actuating element 48 and the sealing strip 38 are tilted about their common rotation or pivot axis 70, 68, wherein the edge 72 of the leaf 26 slides along the contact surface 76 of the actuating element 48. When the leaf 26 (still positioned away from the frame 12) has reached the closed position, a tip 78 of the actuating element 48 bears against the front side 50 of the leaf 26; cf. FIGS. 11 and 12. The sealing strip 38 is then in an intermediate position. In the intermediate position, the sealing lip 52 does not yet touch the leaf 26. The actuating element 48 still projects from the corner piece 46 and protrudes towards the leaf 26.

When the leaf 26 is positioned against the frame 12 by actuating the handle 28 (cf. FIG. 1), the actuating element 48 is raised further together with the sealing strip 38 until the (fully) raised position is reached, cf. FIG. 10. The actuating element 48 is now accommodated in the corner piece 46. In the region of the sealing lip 52, the sealing profile 56 can be bent further upwards relative to the stiffening element 58, cf. also FIG. 8. Both the sealing lip 52 and the tip 78 of the actuating element 48 bear against the front side 50 of the leaf 26 when the leaf is completely closed and locked by turning the handle 28, see FIGS. 8 and 10.

There is also an additional seal 80 on the underside of the leaf 26. When the leaf 26 bears against the frame 12, the additional seal 80 bears against a vertical sealing surface 82 within the sill 14, cf. FIGS. 8 and 10. When the leaf 26 is moved away from the frame 12, the additional seal 80 is lifted from the vertical sealing surface 82, cf. FIGS. 7, 9 and 11. The additional seal 80 therefore does not rub against the sealing surface 82 of the sill 14 when the leaf 26 is displaced.

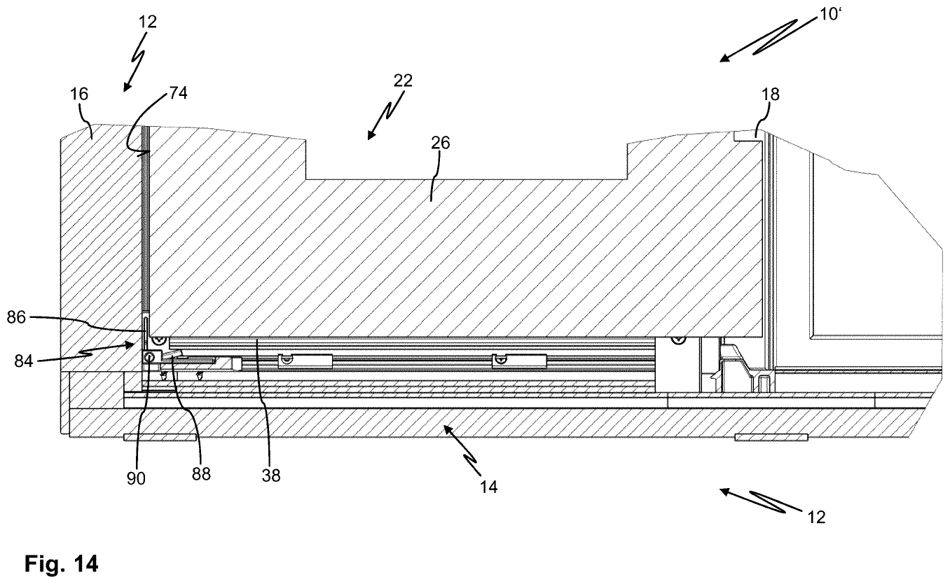

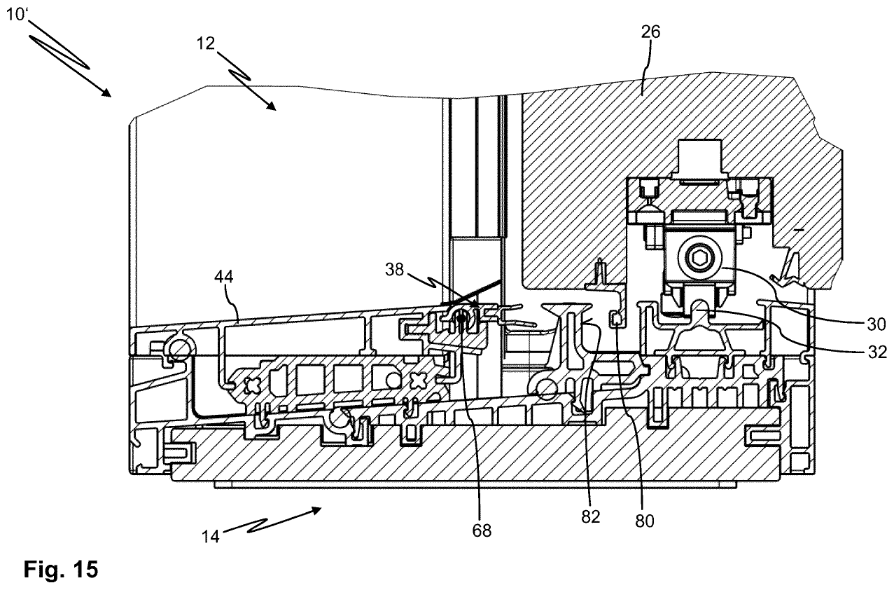

FIGS. 13 and 14 show a further embodiment of a sliding door 10′ with a leaf 26 and a frame 12. In FIG. 13, the leaf 26 partially opens a doorway 22; a sealing strip 38 is in a lowered position. In FIG. 14, the leaf 26 is in a closed position, in which it has moved up to a vertical mullion 16 of the frame 12 and covers the doorway 22; the sealing strip 38 is in a raised position.

With regard to its basic functionality, the sliding door 10′ shown in FIGS. 13 and 14 corresponds to the sliding door 10 sketched in FIG. 1 and shown in more detail in FIGS. 2 to 12. In this respect, reference is made to the above description. The following section primarily describes the differences with regard to the design and operation of the sealing strip 38.

In the sliding door 10′, an actuating element 84 is formed for the sealing strip in the form of a lever with two legs 86, 88 angled against one another. The two legs 86, 88 can form an angle of approximately 75° (e.g., 75°+/−10°). The actuating element 84 is rotatable about a horizontally extending rotation axis 90, which is oriented orthogonally to a sill 14 and a running rail 32 running in the sill 14 (cf. FIG. 1).

The leg 86 of the actuating element 84 extends upwards from the rotation axis 90. With the leaf 26 open, the leg 86 is inclined away from the vertical mullion 16 and towards the leaf 26, see FIG. 13. The leg 88 engages under the sealing strip 38. With the leaf 26 open, the leg 88 runs horizontally.

Shortly before the leaf 26 reaches the closed position (see FIG. 14) when being pushed closed, a narrow side 74 of the leaf 26 facing the vertical mullion 16 hits the leg 86 of the actuating element 84. As the leaf 26 is moved further to the closed position, the leg 86 is pressed towards the vertical mullion 16, causing the actuating element 84 to rotate about its rotation axis 90. The leg 88 is thereby deflected upwards and lifts the sealing strip 38 into the raised position. With the sliding door 10′, when the leaf 26 is positioned to bear against the frame 12, the sealing strip 38 is not raised further.

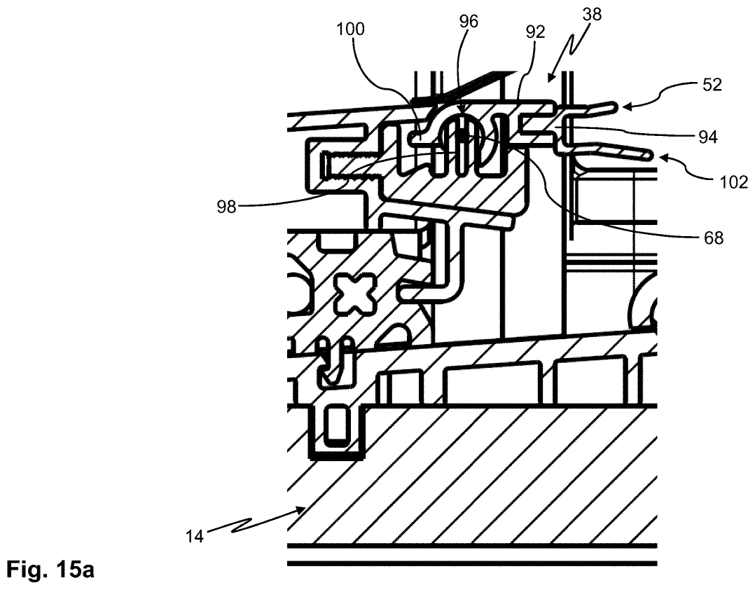

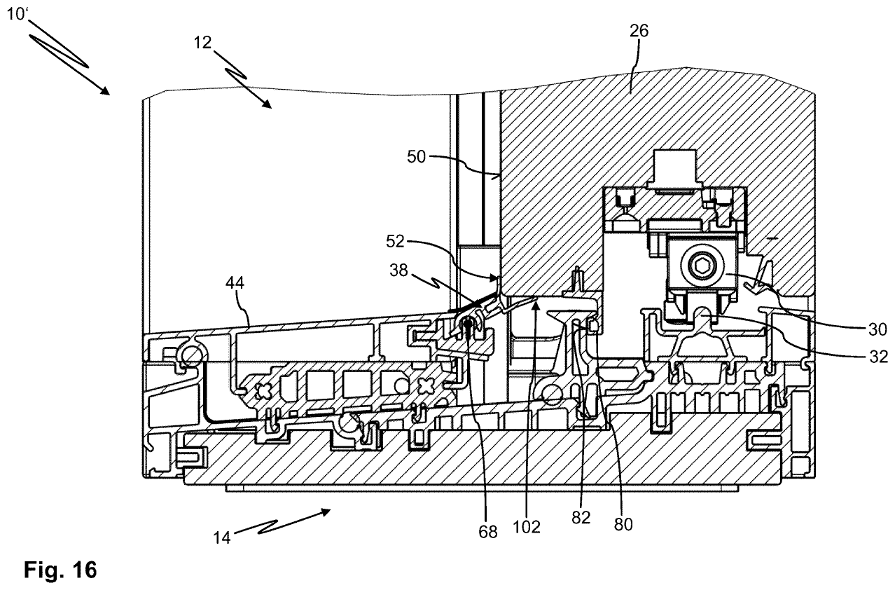

With sliding door 10′, the sealing strip 38 is formed with a support profile 92 and a sealing element 94, cf. FIGS. 15, 15a and 16. The sealing element 94 is fastened to the support profile 92.

The support profile 92 has a calotte groove 96 with a circular cross-section, cf., in particular, FIG. 15 a. A hinge projection 98 in the sill 14 engages the calotte groove 96. As a result of the hinge projection 98 engaging the calotte groove 96, the sealing strip 38 is pivotally mounted on the sill 14, wherein a pivot axis 68 extends along the sill 14 parallel to the running rail 32 and the leaf plane of the leaf 26. The rotation axis 90 of the actuating element 84 and the pivot axis 68 of the sealing strip 38 run perpendicular to each other in the sliding door 10′.

On the support profile 92, a stop portion 100 is formed on the far side of the calotte groove 96 when viewed from the sealing element 94. In the raised position of the sealing strip 38, the stop portion 100 bears against the sill 14, so that the sealing strip 38 cannot rise further, cf. FIG. 16.

The sealing element 94 has two sealing lips 52, 102. When the leaf 26 is positioned against the frame 12, the sealing lip 52 bears against a front side 50 of the leaf 26, cf. FIG. 16. The sealing lip 52 can be bent upwards relative to the support profile 92. At the same time, the sealing lip 102 bears against the underside of the leaf 26. To achieve this, the sealing lip 102 is arranged below the sealing lip 52; moreover, the sealing lip 102 protrudes further than the sealing lip 52, cf. also FIG. 15. As a result of the sealing lip 102 bearing against the underside of the leaf 26, the sealing lip is bent downwards relative to the support profile 92.

In case of the sliding door 10′, too, the sealing strip 38 together with sealing strands 36a-36c (cf. also FIG. 1) and compressible corner pieces 104 forms a sealing arrangement 34 fully surrounding the doorway 22. In particular, the sealing lip 52 with the sealing strands 36a-36c and the corner pieces 104 provides a seal in the plane of the front side 50 of the leaf 26.

In summary, the invention relates to a sill arrangement having a pivotable sealing strip for a sliding door with a leaf which is displaceable along a running rail and which can be moved in the horizontal direction perpendicular to the running rail in order to be positioned against a frame or to be set away from the frame. When the leaf is open, the sealing strip is lowered, so that it terminates flush with a sill. When the leaf is pushed closed along the running rail, the sealing strip is at least partially raised. When the pushed-closed leaf is positioned against the frame, the sealing strip can be raised further. With the leaf bearing against the frame, the raised sealing strip provides sealing against a vertical front side of the leaf, the front side being oriented parallel to the running rail. In particular, the leaf is continuously peripherally sealed against the frame in the plane of the front side of the leaf, this sealing being provided by the sealing strip and further sealing structures fixed to the frame.

### LIST OF REFERENCE SIGNS

Sliding door 10
Frame 12
Sill 14
Vertical mullions 16, 18
Upper horizontal mullion 20
Doorway 22
Further field 24
Leaf 26
Handle 28
Carriage 30
Running rail 32
Sealing arrangement 34
Sealing strands 36a, 36b, 36c
Sealing strip 38
Upper side 40 of the sill 14
Walking surface 42
Tread plate 44
Corner piece 46
Actuating element 48
Front side 50
Sealing lip 52
Further corner piece 54
Sealing profile 56
Stiffening element 58
First end region 60
Second end region 62
Insert 63
Groove 64
Deformation portion 66
Pivot axis 68 of the sealing strip 38
Rotation axis 70 of the actuating element 48
Edge 72
Narrow side 74
Contact surface 76
Tip 78
Additional seal 80
Sealing surface 82
Sliding door 10′
Actuating element 84
Legs 86, 88
Rotation axis 90 of the actuating element 84
Support profile 92
Sealing element 94
Calotte groove 96
Hinge projection 98
Stop portion 100
Further sealing lip 102
Corner piece 104

What is claimed is:

1. A sliding door comprising:
a frame and a leaf;
wherein the leaf in a closed position is movable perpendicular to a leaf plane in order to position the leaf to bear against the frame or to set it away from the frame, and wherein the leaf when set away from the frame is displaceable in the leaf plane in order to open or close a doorway;
wherein the frame has a sill at which a sealing strip is arranged, which is pivotable between a lowered and a raised position, wherein a pivot axis of the sealing strip runs parallel to the leaf plane;
wherein in its position when bearing against the frame, the leaf touches the raised sealing strip with a front side; and
wherein the sliding door has an actuating element configured for raising the sealing strip, which is configured to raise the sealing strip from the lowered position when the leaf while set away from the frame is moved to the closed position.

2. The sliding door according to claim 1, wherein the actuating element is configured to move the sealing strip completely to the raised position when the leaf is moved into the closed position.

3. The sliding door according to claim 1, wherein the actuating element is configured to raise the sealing strip to an intermediate position when the leaf is moved to the closed position and wherein, when the leaf is being positioned to bear against the frame, the sealing strip is moved from the intermediate position to the raised position.

4. The sliding door according to claim 1, wherein a rotation axis of the actuating element is oriented perpendicular to the pivot axis of the sealing strip.

5. The sliding door according to claim 4, wherein the actuating element is a rotatably mounted lever with two legs, wherein a first leg engages under the sealing strip and a second leg protrudes upwards, wherein the second leg is deflected by the leaf when the leaf is moved to the closed position.

6. The sliding door according to claim 1, wherein a rotation axis of the actuating element corresponds to the pivot axis of the sealing strip.

7. The sliding door according to claim 6, wherein the actuating element has a contact surface for the leaf that is inclined relative to the rotation axis, and wherein the contact surface protrudes horizontally beyond the sealing strip in the lowered position of the sealing strip.

8. The sliding door according to claim 1, wherein the sealing strip has a sealing profile with two end regions, wherein a first end region of the sealing profile forms at least one sealing lip for contact with the leaf and a second end region of the sealing profile is fixed to a tread plate of the sill, and wherein a deformation portion is formed in the sealing profile between the second end region and the first end region, which deformation portion defines the pivot axis.

9. The sliding door according to claim 8, wherein the sealing strip has a stiffening element for the sealing profile which is arranged between the deformation portion and the sealing lip, wherein the stiffening element is embedded in the sealing profile.

10. The sliding door according to claim 1, wherein the sealing strip has a support profile and a sealing element held on the support profile, wherein the support profile is pivotably mounted on the sill.

11. The sliding door according to claim 10, wherein the support profile has a calotte groove extending along the pivot axis, into which a hinge projection of the sill engages.

12. The sliding door according to claim 10, wherein the support profile has a stop portion for contact with the sill when the sealing strip is in the raised position.

13. The sliding door according to claim 1, wherein the frame has a vertical mullion and a corner piece arranged in the corner region of the vertical mullion and the sill, against which corner piece the leaf bears in its position when bearing against the frame.

14. The sliding door according to claim 13, wherein, when the leaf is positioned to bear against the frame, the actuating element is accommodated in the corner piece.

15. The sliding door according to claim 13, wherein the actuating element bears against the corner piece when the sealing strip is in the raised position.

16. The sliding door according to claim 1, wherein the frame has a peripheral sealing arrangement that runs continuously in one plane for the leaf to abut, wherein the sealing strip is part of the peripheral sealing arrangement.

17. The sliding door according to claim 1, wherein the sill has a running rail along which the leaf is displaceable when the leaf is set away from the frame.

18. The sliding door according to claim 17, wherein the leaf has a carriage for moving along the running rail, wherein the carriage is coupled to a handle and actuation of the handle causes a movement of the leaf perpendicular to the running rail.

19. The sliding door according to claim 1, wherein the sealing strip has a sealing lip for front-side contact with the leaf and a further sealing lip for contact with the underside of the leaf.

20. The sliding door according to claim 1, wherein an additional seal is arranged on the underside of the leaf, and wherein a vertical sealing surface is formed within the sill for contact of the additional seal when the leaf is bearing against the frame.

21. The sliding door according to claim 1, including a sill arrangement comprising the sill and the sealing strip, wherein the sealing strip is arranged at the sill to be pivoted between the lowered and the raised position, wherein the pivot axis runs along the sill, and wherein the sill arrangement further comprises the actuating element for raising the sealing strip, which is configured to raise the sealing strip from the lowered position when the leaf of the sliding door is moved along the sill to the closed position.

22. The sliding door according to claim 21, wherein the frame comprises two vertical mullions, an upper horizontal mullion and the sill arrangement.

23. The sliding door according to claim 6, wherein the actuating element is fixed to the sealing strip.
